(19) United States
(12) Patent Application Publication
(10) Pub. No.: US 2006/0091693 A1
(43) Pub. Date: May 4, 2006

(54) Removable visor

(75) Inventor: Louis M. Spoto, Huntley, IL (US)

Correspondence Address: SWANSON & BRATSCHUN L.L.C., 1745 SHEA CENTER DRIVE, SUITE 330, HIGHLANDS RANCH, CO, 80129, US

(73) Assignee: Waveland Industries, Inc., Huntley, IL (US)

(21) Appl. No.: 10/979,739

(22) Filed: Nov. 2, 2004

(51) Int. Cl. B60J 3/00

(52) U.S. Cl. 296/97.2

(57) ABSTRACT

A removable auto visor including a film body suitable for removable adhesion to an automobile windshield, the film body further being suitable for blocking a portion of sunlight falling upon it. The film body may have more than one part, but the combined elements of the film body will preferably define an isosceles trapezoid having a top edge, a bottom edge, and two side edges. The top edge and bottom edge of the film body will form the parallel bases of the isosceles trapezoid shape. The longer trapezoidal base will preferably be the top edge of the film body, and sized such that this edge abuts the top edge of an automobile windshield in use and the film body covers a portion of the windshield space between existing passenger and driver side permanent visors.

### RELATED APPLICATION DATA

This application claims priority to U.S. Provisional Application Ser. No. 60/516,885, filed Nov. 3, 2003, entitled STATIC CLING PERFORATED VISOR, which application is incorporated herein by reference in its entirety.

### TECHNICAL FIELD

The present invention is directed toward a motor vehicle visor, and more particularly toward a removable and repositionable static cling perforated visor.

### BACKGROUND ART

Automobile visors mounted on the front driver and passenger side of an automobile are well known in the art. Typical visors are fabricated from an opaque material and are mounted on a hinged device which allows the visor to be folded down to block sunlight from the driver's eyes, or folded up to increase visibility at the discretion of the driver. Most traditional auto visors do not extend toward the center of an automobile windshield far enough to block the sun if it is shining directly through the uppercenter of the window in the general area of the rearview mirror. A need exists in the art for an aftermarket visor which can be applied by the auto owner or a technician to the central area of a windshield, thus blocking the sun which strikes the windshield in the area which is not covered by traditional visors.

### SUMMARY OF THE INVENTION

A removable auto visor includes a film body suitable for removable adhesion to an automobile windshield, the film body further being suitable for blocking a portion of sunlight falling upon it. The film body may have more than one part, but the combined elements of the film body will define an isosceles trapezoid having a top edge, a bottom edge, and two side edges. The top edge and bottom edge of the film body will form the parallel bases of the isosceles trapezoid shape. The longer trapezoidal base will preferably be the top edge of the film body, and sized such that this edge abuts the top edge of an automobile windshield in use and the film body covers a portion of the windshield space between existing passenger and driver side permanent visors.

In one embodiment of the removable visor, the film body includes multiple perforations. In such an embodiment, the perforations may be placed in a repeating pattern which is consistent throughout the film body. Alternatively, the multiple perforations may be placed in the film body in a varying pattern, or variably sized perforations may be used which provide for a special design or a vertically distributed and varying level of sunlight transmission through the film body.

The mechanism of removable adhesion may be static cling between the film body and the windshield or an adhesive substance applied directly to the film body. Preferably, the removable automobile visor will further include a removable, protective backing applied to the film body. The protective backing will serve to protect any adhesive substance or keep the static cling surface clean and dust free.

In another embodiment, the film body may further include a cutout defining an opening through which a rearview mirror support may pass. Alternatively, the film body may be fabricated in multiple sections to fit around the rearview mirror support. In any embodiment, the film body may be fabricated from a material which may be trimmed to size using household scissors, facilitating aftermarket or automobile owner application of the removable visor.

Although described above with respect to an apparatus, the present invention may be implemented as a method of manufacturing the removable visor described above.

### BRIEF DESCRIPTION OF THE DRAWINGS

FIG. 1 is a plan view of a removable visor as disclosed herein;

FIG. 2 is a close up plan view of the preferred dot pattern for the removable visor of the present invention;

FIG. 3 is a plan view of a removable visor featuring a cutout portion for rearview mirror mounting apparatus; and

FIG. 4 is a view of the removable visor as placed in use on an automobile windshield.

### DETAILED DESCRIPTION OF THE PREFERRED EMBODIMENT

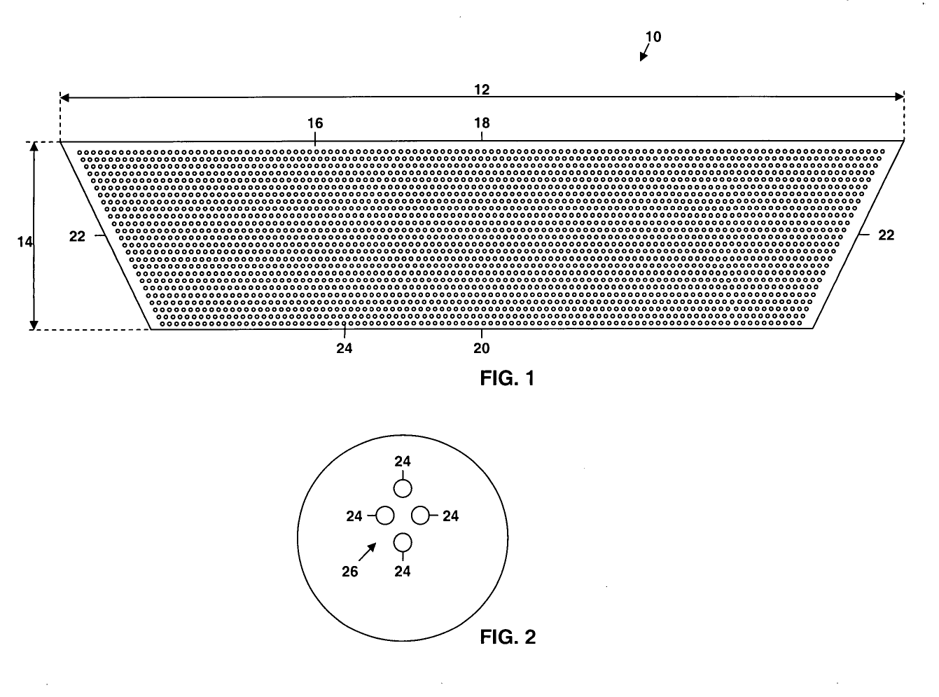

A removable visor 10 is shown in FIG. 1. The removable visor 10 has a select width 12 and a select height 14. Typically, the select width 12 will be at least twice the select height 14. In a highly preferred embodiment, the select width 12 is 11.5 inches, and the select height is 3.5 inches. The removable visor 10 includes a film body 16 suitable for removable adhesion to an automobile windshield. The film body 16 is further suitable for blocking a portion of the sunlight falling upon it which would otherwise shine in a driver's eyes. The removable visor 10 may be of any appropriate shape, but preferably the film body 16 defines a top edge 18, a bottom edge 20, and two side edges 22 such that the four edges together define a substantially isosceles trapezoid shape, with the top edge 18 and the bottom edge 20 defining the parallel bases of the trapezoid. Preferably, the top edge 18 will be the longer base of the trapezoid. This edge will, in use, abut the top of the automobile windshield such that the film body 16 covers a portion of the windshield space between existing passenger and driver side permanent visors. In addition, it is preferable that the select width 12 corresponding to the top edge 18 be less than the width of the top of a typical automobile windshield. In addition, it is preferable that the width 12 and the height 14 are selected to both effectively fill the space between traditional automobile sun visors and avoid unduly restricting visibility out of a car windshield.

The removable visor 10 is preferably manufactured from a flexible plastic film having a defined thickness. Preferably, the film is darkened or opaque and perforated by multiple perforations 24 which may be arranged in a consistent geometric shape or arranged in a non-uniform pattern. The perforations 24 may be circular or of another shape. In addition, the size of the perforations may be varied. By varying the size and distribution of the perforations, designs or patterns such as commonly recognized automobile logos may be formed. Such a design or logo may be visible some distance away from the removable visor 10, however, the operational characteristics of the removable visor 10 will not be compromised. In addition, the pattern or distribution or size of the perforations 24 may be made to vary such that the sunlight transmission characteristics of the removable visor 10 vary along a vertical, horizontal, radial, or other gradient. The film body 16 of the removable visor 10 may be translucent, allowing the passage of a limited amount of light, or opaque. Typically, the perforations 24 will pass a selectively reduced amount of light through the removable visor 10. In addition, the perforations 24 allow a driver or passenger relatively unobstructed views of traffic signals or other lights.

A representative pattern 26 of perforations 24 is shown in FIG. 2. The removable visor 10 is operational with any pattern 26 or non-uniform arrangement of perforations 24, and the embodiment shown in FIG. 2 is for illustrative purposes and should not be construed to limit the scope of this invention in any way.

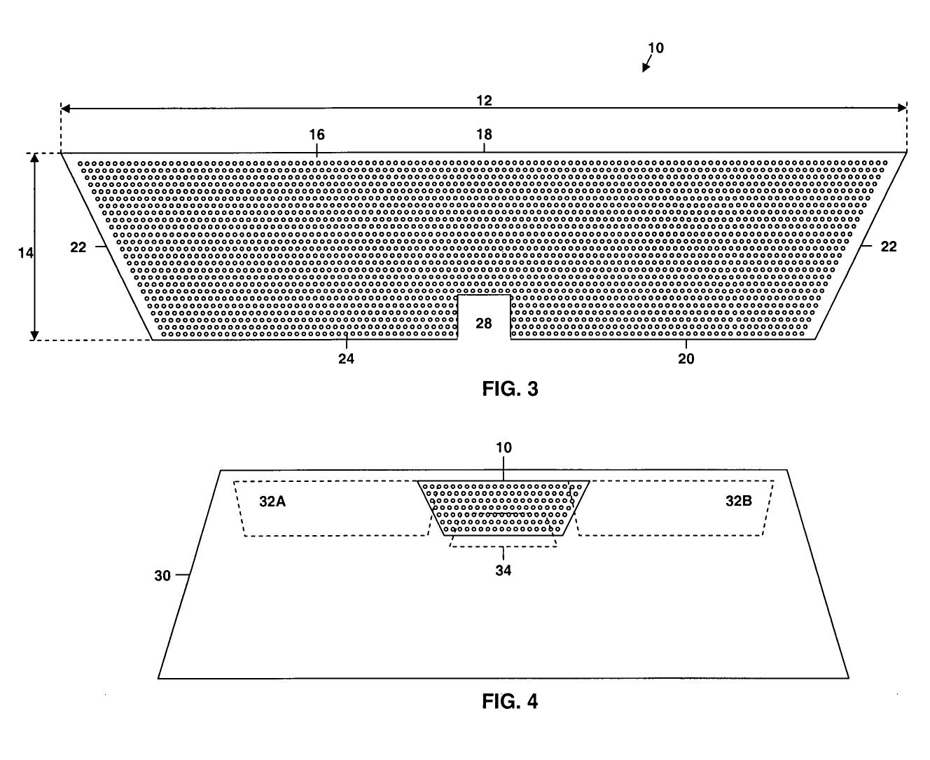

An alternative embodiment of the removable visor 10 is shown in FIG. 3. In this embodiment, a cutout portion 28 is removed from the film body 16. The cutout portion 28 may be selectively configured to allow the mounting apparatus of a rearview mirror to pass through the removable visor 10. The cutout portion 28 may be located along the bottom edge 20 as is shown in FIG. 3, or the cutout portion 28 may be located along the top edge 18, or in the middle of the film body 16 as is necessary to accommodate the rearview mirror configurations of various automobiles. Alternatively, the cutout portion 28 may bisect the removable visor 10 resulting in a removable visor 10 having multiple parts, each part of which is adhered to the windshield on either side of a rearview mirror mounting apparatus such that the parts together form the basic isosceles trapezoidal shape.

FIG. 4 illustrates the proper positioning of the removable visor 10. For use, the removable visor 10 must be mounted to the interior of an automobile windshield 30 in the space between the traditional automobile visors 32A, 32B. The removable visor 10 may be configured as described above to adhere around a rearview mirror 34. In a preferred embodiment, static cling generated between the film body 16 and the windshield securely but removably bonds the removable visor 10 to the interior surface of the windshield. A static cling embodiment is preferable because the ease of applying the removable visor 10 is enhanced and the installation is not permanent. Alternatively, the film body 16 may be backed with an adhesive resulting in a semi-permanent installation.

The perforations 24 ease the application of the removable visor 10 by allowing air trapped behind the film body 16 during application to be easily removed. In addition, the perforations 24 allow the removable visor 10 to lay flat on the windshield surface even though the windshield may have substantial curvature. In contrast, a non-perforated film will tend to crease and fold due to the curvature along multiple axis of curvature of the windshield.

In addition, the perforations 24 allow the removable visor 10 to evenly expand, maintaining its positional integrity as the removable visor 10 is heated by the sun. This attribute also reduces the risk of thermal stress being induced in the windshield as a result of the adhesion of a removable visor 10.

The removable visor 10 is advantageous over a permanent, factory installed coating on the interior of a windshield because the removable visor 10 is repositionable and not permanent. In addition, the removable visor 10 may be cut and sized to precisely meet the needs of the automobile owner with simple, household tools such as scissors.

A further embodiment of the present invention is a method of manufacturing a removable visor 10. The method includes providing a film body 16 suitable for removable adhesion to an automobile windshield, the film body 16 further being suitable for blocking a portion of the sunlight falling upon it. The method of manufacture further includes shaping the film body 16 into any suitable shape, but preferably a substantially isosceles trapezoid. Typically, the film body 16 shaped as an isosceles trapezoid will have a top edge 18 which is the longer base of the trapezoid. This top edge 18 will be sized to abut the top of an automobile windshield, but shall be somewhat shorter in length than a typical automobile windshield. The shaping process may be accomplished with conventional cutting tools and dies or with computer controlled laser based cutting apparatus.

The method of manufacturing a removable visor 10 may further include forming multiple perforations 24 though the film body 16. The multiple perforations 24 may be formed during the fabrication of the film body 16. Alternatively, perforations 24 can be cut or drilled by any means after fabrication of the film body 16. In a highly preferred embodiment, mechanical or laser apparatus are used to form the perforations 24, allowing the use of different sized or shaped perforations 24 throughout the film body 16 which can be used to form a vertical, horizontal or raidal transmission gradient or a logo or design.

The description of the present invention has been presented for purposes of illustration and description, but is not intended to be exhaustive or limited to the invention in the form disclosed or as a limitation on the scope of the claims. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A removable automobile visor comprising:
a film body suitable for removable adhesion to an automobile windshield, the film body further being configured for blocking a portion of sunlight falling upon it, the film body comprising one or more parts defining a top edge, a bottom edge and two side edges wherein the four edges define a substantially isosceles trapezoid sized to cover a portion of windshield space between existing passenger and driver's side permanent visors, with a longer base of the trapezoid having a width less than the width of the top of the automobile windshield.

2. The removable automobile visor of claim 1 further comprising multiple perforations through the film body.

3. The removable automobile visor of claim 2 wherein the multiple perforations are formed through the film body in a repeating pattern which is consistent throughout the film body.

4. The removable automobile visor of claim 2 wherein the multiple perforations are formed through the film body in a varying pattern which provides for a distributed level of sunlight transmission through the film body.

5. The removable automobile visor of claim 2 wherein the multiple perforations are formed through the film body in a select pattern which defines a recognizable design.

6. The removable automobile visor of claim 2 wherein a first set of the multiple perforations formed through the film body have a first diameter and a second set of the multiple perforations have a second diameter which is different than the first diameter.

7. The removable automobile visor of claim 1 wherein the mechanism of removable adhesion comprises one of:
static cling between the film body and the windshield; and
an adhesive substance applied to the film body.

8. The removable automobile visor of claim 7 further comprising a removable protective backing applied to the film body.

9. The removable automobile visor of claim 1 further comprising a cut-out defining an opening in the film body where a rear view mirror support may pass through.

10. The removable automobile visor of claim 1 wherein the film body is fabricated from a material which may be trimmed to size using household scissors.

11. A method of manufacturing a removable automobile visor comprising:
providing a film body configured for removable adhesion to an automobile windshield, the film body further being suitable for blocking a portion of sunlight falling upon it; and
shaping the film body to a substantially isosceles trapezoid shape sized to cover a portion of windshield space between existing passenger and driver's side permanent visors, with a longer base of the trapezoid having a width less that the width of the top of the automobile windshield.

12. The method of manufacturing a removable automobile visor of claim 11 further comprising forming multiple perforations through the film body.

13. The method of manufacturing a removable automobile visor of claim 12 wherein the multiple perforations are formed through the film body in a repeating pattern which is consistent throughout the film body.

14. The method of manufacturing a removable automobile visor of claim 12 wherein the multiple perforations are formed through the film body in a varying pattern which provides for a distributed level of sunlight transmission through the film body.

15. The method of manufacturing a removable automobile visor of claim 12 wherein the multiple perforations are placed through the film body in a select pattern which defines a recognizable design.

16. The method of manufacturing a removable automobile visor of claim 12 wherein a first set of the multiple perforations placed through the film body have a first diameter and a second set of the multiple perforations have a second diameter which is different than the first diameter.

17. The method of manufacturing a removable automobile visor of claim 11 wherein the mechanism of removable adhesion comprises one of:
fabricating the film body from a material which exhibits static cling when placed adjacent to a windshield; and
applying an adhesive substance to the film body.

18. The method of manufacturing a removable automobile visor of claim 17 further comprising applying a removable protective backing to the film body.

19. The removable automobile visor of claim 11 further comprising cutting an opening in the film body defining a rear view mirror support pass through.
